(19) United States
(12) Patent Application Publication
(10) Pub. No.: US 2024/0303513 A1
(43) Pub. Date: Sep. 12, 2024

(54) Method, Computer Program, and Device for Operating an AI Module

(71) Applicant: Volkswagen Aktiengesellschaft, Wolfsburg (DE)

(72) Inventors: Christoph Pohling, Karlsruhe (DE); Heinz-Dieter Lindemann, Cremlingen (DE)

(73) Assignee: Volkswagen Aktiengesellschaft, Wolfsburg (DE)

(21) Appl. No.: 18/260,368

(22) PCT Filed: Nov. 25, 2021
(86) PCT No.: PCT/EP2021/082962

§ 371 Date: Jul. 5, 2023

(30) Foreign Application Priority Data
Jan. 5, 2021 (DE) 10 2021 200 030.4

(51) Int. Cl. G06N 5/025; B60W 60/00

(52) U.S. Cl. CPC G06N 5/025; B60W 60/00

(57) ABSTRACT

The present disclosure relates to a method, a computer program with instructions, and a device for operating an AI module. The disclosure also relates to an AI module suitable for the method and to a locomotion means that has an AI module or a device according to the teachings herein or is configured to carry out a method according to the teachings herein for operating an AI module. In a first step, a state is determined in which a system operated by the AI module is not in use for its primary purpose. Subsequently, data stored by the AI module are processed by adding a random component. A result of the processing is evaluated and the AI module is adapted depending on the evaluation.

### CROSS-REFERENCE TO RELATED APPLICATIONS

This application claims priority to German Patent Application No. DE 10 2021 200 030.4, filed on Jan. 5, 2021 with the German Patent and Trademark Office. The contents of the aforesaid Patent Application are incorporated herein for all purposes.

### TECHNICAL FIELD

The present invention relates to a method, a computer program with instructions, and a device for operating an AI module. The invention also relates to an AI module suitable for the method and to a locomotion means that has an AI module or a device or is configured to carry out a method for operating an AI module.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

Artificial intelligence (AI) is a continuously expanding field that offers unique potential for human-machine interaction and applications in science and industry. AI is already part of the daily routine in the life of most people today, for example, in the use of engines, voice commands, or receiving personalized advertising. The development of AI is strongly linked with the developments in the field of computer science and engineering. In parallel with the information technologies mentioned above, the automotive industry is facing complex challenges: computer vision and autonomous driving, the Internet of Things, providing features “over the air,” the requirements of customers in terms of new (third-party) applications and navigation systems require large amounts of data, which must be processed in short periods of time, and complex analysis strategies. Therefore, AI algorithms have emerged as important components of today's motor vehicles.

In this context, US 2020/0033868 A1 describes a system for autonomously generating driving strategies. The system comprises a series of autonomous driving agents and a module for generating driving strategies. This module comprises a series of driving strategy learning modules for generating and improving driving strategies on the basis of the collective experiences collected by the driving agents. The driving agents can collect driving experiences to create a basis of knowledge. The driving strategy learning modules can process the collective driving experiences to extract driving strategies.

### SUMMARY

A need exists to provide improved solutions for operating an AI module.

The need is addressed by a method, by corresponding instructions, and by a device having the features of the independent claims. Embodiments of the invention are described in the dependent claims, the following description, and the drawings.

### BRIEF DESCRIPTION OF THE DRAWINGS

FIG. 1 schematically shows an example method for operating an AI module;

FIG. 2 shows a first embodiment of a device for operating an AI module;

FIG. 3 shows a second embodiment of a device for operating an AI module;

FIG. 4 schematically shows an embodiment of locomotion means, in which a solution according to the teachings herein is implemented;

FIG. 5 illustrates by way of example a normal operation of an AI module in a locomotion means;

FIG. 6 illustrates by way of example a state of the AI module in which a system operated by the AI module is not in use for its primary purpose; and

FIG. 7 illustrates by way of example a state of the AI module after an expansion of its capabilities.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a method for operating an AI module comprises the steps of:
Determining a state in which a system operated by the AI module is not in use for its primary purpose;
Processing of stored data by the AI module by adding a random component;
Evaluating a result of the processing; and
Adapting the AI module depending on the evaluation.

In some embodiments, a computer program comprises instructions that, when executed by a computer, cause the computer to carry out the following steps for operating an AI module:
Determining a state in which a system operated by the AI module is not in use for its primary purpose;
Processing of stored data by the AI module by adding a random component;
Evaluating a result of the processing; and
Adapting the AI module depending on the evaluation.

The term computer should be understood in a broad sense. In particular, it also comprises control devices, embedded systems, and other processor-based data processing devices.

The computer program can be provided, for example, to be called up electronically or can be stored on a computer-readable storage medium.

In some embodiments, a device for operating an AI module has:
A monitoring module for determining a state in which a system operated by the AI module is not in use for its primary purpose;
A data module for providing stored data for processing by the AI module by adding a random component;
An evaluation module for evaluating a result of the processing; and
A control module for adapting the AI module depending on the evaluation.

The solution according to the disclosure herein enables a system of the AI to develop new strategies and alternative mechanisms and assess them on the basis of existing data. When processing the data, the optimization process uses random components to create new alternatives to existing or even future problems. In other words, this enables the AI to develop ideas. These can be based on random but intentionally initiated computational actions, such as how human ideas can be formed from random thoughts. The alternatives provided in this way can be applied in the context of an existing problem or can be called up from what has been learned for future tasks. This enables the AI to provide a solution that is more efficient than existing strategies or meets future but unforeseen requirements, or that could not be calculated within the given time span of a current situation. The described mechanism is referred to as “artificial random thoughts” (ART).

In some embodiments, the stored data comprises data from earlier situations processed by the AI module. This allows failures of the AI functionality to be reduced by simulating earlier failed situations. By adding a random component, potentially better results or, respectively, strategies can come to light. These are stored so that they can be applied successfully to future tasks.

In some embodiments, the random component is applied to the stored data. In this case, the random component may cause random perturbations of the stored data. The perturbations are a simple way to enable the AI module to discover improved data processing strategies. In addition, distortions of training data sets through repeated AI decisions on stored and still actively modified input data can be reduced.

In some embodiments, the random component is applied to at least one algorithm or at least one parameter of the AI module. In this way as well, the AI module can detect better or more efficient data processing strategies.

In some embodiments, correlations in data sets are detected during the evaluation of results of the processing. This can be used in particular to reduce the input variables to be processed for a task. By analyzing large amounts of collected data, hidden correlations in the data sets, including human inputs, can be revealed. This can be beneficial in order to obtain certain information more easily, more quickly, or more cheaply, for example, by reducing the number of sensors or, respectively, amount of sensor data required for a specific task.

A method, an AI module, or a device according to the present disclosure is used particularly beneficially in a locomotion means. The locomotion means can be, in particular, a motor vehicle, for example a passenger car or a commercial vehicle, but can also be a ship, an aircraft, for example an eVTOL, etc. The AI module can be used in particular for computer vision or autonomous driving tasks. This these tasks are usually very complex, the use of artificial intelligence for this purpose is particularly beneficial. In an AI module of a locomotion means, a state in which the system operated by the AI module is not in use for its primary purpose can be determined in particular when the locomotion means is parked or not in motion. In this case, short periods of time of non-use can also be taken advantage of, for example, when stopped at traffic lights. In addition to the use of a solution according to the disclosure in a locomotion means, however, the use in other areas is also beneficial, for example in robots, medical devices, or consumer devices.

In some embodiments, an AI module is configured to be used in a method according to the teachings herein or with a device according to the teachings herein. For this purpose, the AI module can provide, for example, information about its operating state or can be configured to enable the algorithms or parameters used to be adapted.

Further features of the present invention will become apparent from the following description and the appended claims in conjunction with the FIGS..

In order to better understand the principles of the present invention, further embodiments are discussed in greater detail below based on the FIGS.. It should be understood that the invention is not limited to these embodiments and that the features described can also be combined or modified without departing from the scope of protection of the invention as defined in the appended claims.

Specific references to components, process steps, and other elements are not intended to be limiting. Further, it is understood that like parts bear the same or similar reference numerals when referring to alternate FIGS.

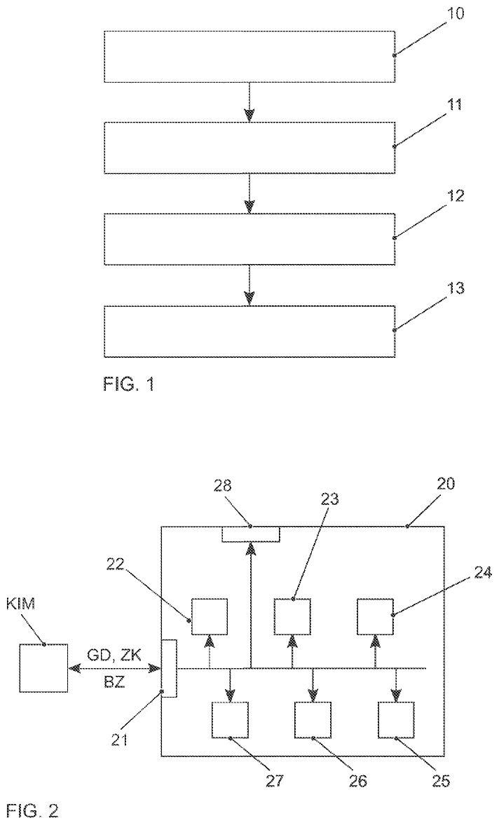

FIG. 1 schematically shows a method for operating an AI module. The AI module can be used, for example, in a locomotion means, for example, for computer vision or autonomous driving tasks. However, it can also be an AI module that is used in a robot, a medical device, or a consumer device. As a first step, a state is determined 10 in which a system operated by the AI module is not in use for its primary purpose. In an AI module of a locomotion means, this can be the case in particular when the locomotion means is parked or not in motion. In this case, short periods of time of non-use can also be taken advantage of, for example, when stopped at traffic lights. Subsequently, data stored by the AI module are processed 11 by adding a random component. The stored data can be in particular data from earlier situations processed by the AI module. The random component can be applied, for example, to the stored data. In this case, the random component may for example cause random perturbations of the stored data. Alternatively or in addition, the random component can be applied to at least one algorithm or at least one parameter of the AI module. A result of the processing is evaluated 12 and the AI module is adapted 13 depending on the evaluation. During the evaluation of the results, correlations in data sets can be detected, for example. This can be used in particular to reduce the input variables to be processed for a task.

FIG. 2 shows a simplified schematic representation of a first embodiment of a device 20 for operating an AI module KIM. The AI module KIM can be used, for example, in a locomotion means, for example, for computer vision or autonomous driving tasks. However, it can also be an AI module KIM that is used in a robot, a medical device, or a consumer device. The device 20 has an interface 21, through which the device 20 can communicate with the AI module KIM. A monitoring module 22 is configured to determine a state in which a system operated by the AI module KIM is not in use for its primary purpose. In an AI module KIM of a locomotion means, this can be the case in particular when the locomotion means is parked or not in motion. In this case, short periods of time of non-use can also be taken advantage of, for example, when stopped at traffic lights. To do so, the monitoring module 22 can, for example, evaluate information about an operating state BZ that is provided by the AI module KIM or by another source. A data module 23 is configured to provide stored data GD for processing by the AI module KIM by adding a random component ZK. The stored data GD can be in particular data from earlier situations processed by the AI module KIM. The random component can be applied, for example, to the stored data GD. In this case, the random component ZK may for example cause random perturbations of the stored data GD. Alternatively or in addition, the random component ZK can be applied to at least one algorithm or at least one parameter of the AI module KIM. An evaluation module 24 is configured to evaluate a result of the processing. A control module 25 is configured to adapt the AI module KIM depending on the evaluation. The evaluation module 24 can also be configured to detect correlations in data sets. This can be used in particular to reduce the input variables to be processed for a task.

The monitoring module 22, the data module 23, the evaluation module 24, and the control module 25 can be controlled by a checking module 26. Through a user interface 28, settings of the monitoring module 22, the data module 23, the evaluation module 24, the control module 25, or the checking module 26 can be changed if necessary, or new strategies or, respectively, results that have been found from the device 20 can be assessed by an operator in the context of supervised learning. The data accruing in the device 20 can be saved as needed in a memory 27, for example, for later evaluation or for use by the components of the device 20. In addition, the stored data GD for the processing by the AI module KIM can also be saved in the memory 27. The monitoring module 22, the data module 23, the evaluation module 24, the control module 25, and the checking module 26 can be implemented as dedicated hardware, for example as integrated circuits. Of course, however, they can also be combined partially or fully or implemented as software that runs on a suitable processor, for example, on a GPU or a CPU. The interface 21 can be implemented as a bidirectional interface or in the form of a separate input and output. In addition, the device 20 can alternatively also be integrated into the AI module KIM or be implemented in a single control device.

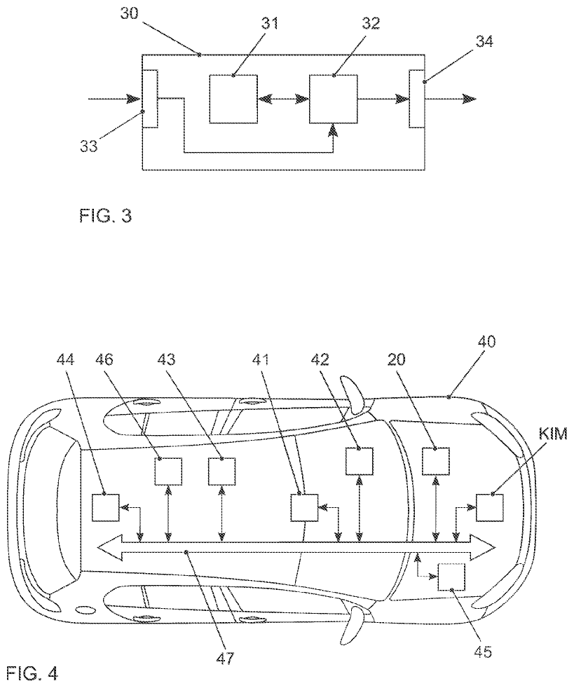

FIG. 3 shows a simplified schematic representation of a second embodiment of a device 30 for operating an AI module. The device 30 has a processor 32 and a memory 31. The device 30 can be, for example, a computer or a control device. In the memory 31, instructions are saved that, when executed by the processor 32, cause the device 30 to carry out the steps according to one of the described methods. The instructions saved in the memory 31 thus embody a program that can be executed by the processor 32 and that implements the method according to the teachings herein. The device 30 has an input 33 for receiving information, for example data from a sensor system of the locomotion means or data that has been received via a data transmission unit. Data generated by the processor 32 is provided through an output 34. It can also be saved in the memory 31. The input 33 and the output 34 can be combined to form a bidirectional interface.

The processor 32 can comprise one or more processor units, for example microprocessors, digital signal processors, or combinations thereof.

The memory 27, 31 in the described embodiments can have both volatile and non-volatile memory regions and comprise a wide variety of storage devices and storage media, for example hard disks, optical storage media, or semiconductor memory.

In the following, a further embodiment will be explained based on FIG. 4 to FIG. 7.

FIG. 4 schematically shows a locomotion means 40, in which a solution is implemented. The locomotion means 40 is in this example a motor vehicle. The motor vehicle has at least one AI module KIM, for example, for computer vision or autonomous driving tasks. The motor vehicle also has a device 20 for operating the AI module KIM. Of course, the device 20 can also be integrated into the AI module KIM. Additional components of the motor vehicle are a sensor system 41 for detecting surroundings information, a user interface 42, a navigation system 43, a data transmission unit 44, and a series of assistance systems 45, of which one is shown as an example. For example, the sensor system 41 can comprise a radar sensor, a lidar sensor, acceleration sensors, one or more cameras or ultrasonic sensors. GPS data can be provided as needed by the navigation system 43. A connection to service providers or other motor vehicles can be established by means of the data transmission unit 44. A memory 46 is present for storing data. The exchange of data between the various components of the motor vehicle takes place over a network 47.

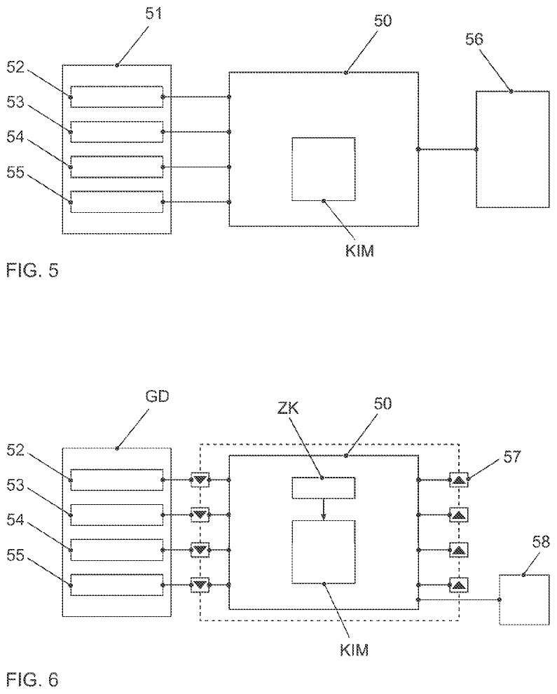

FIG. 5 illustrates normal operation of an AI module KIM in a locomotion means. During operation, the locomotion means continuously obtains input data from various sources 51, for example, sensor data 52, user inputs 53, “over-the-air” data 54, or other data 55. The data is processed by a computer-assisted system 50 that comprises at least one AI module KIM. The AI module KIM processes the data and generates specific outputs 56, for example, information to be displayed or active interventions or assistance for a current driving situation. The possible actions and solutions, however, are limited to the knowledge available at the given point in time.

FIG. 6 illustrates a state of the AI module KIM in which the AI module KIM is not in use for driving operation. The data processing by the locomotion means is expanded by the ART approach while the locomotion means is not in use, i.e., by the use of artificial random thoughts. Input data GD from files as well as possible algorithms or parameter sets are actively manipulated or, respectively, randomly changed, i.e., a random component ZK is introduced to improve existing strategies. Each result is assessed with regard to its suitability, which is symbolized by the shift register 57, and, if its suitability is confirmed, it is saved in a file 58.

Continuous recordings of telemetric data, for example, can serve as input data GD, which enables the simulation of earlier driving events. The ART approach can then be used to reduce failures of the AI functionality of the locomotion means. For this purpose, earlier situations can be simulated, for example, sign a failed traffic recognition, while (randomized) disturbances are applied to the original data, for example, with regard to the image postprocessing. Potentially better results or, respectively, strategies are stored so that they can be applied successfully to future tasks.

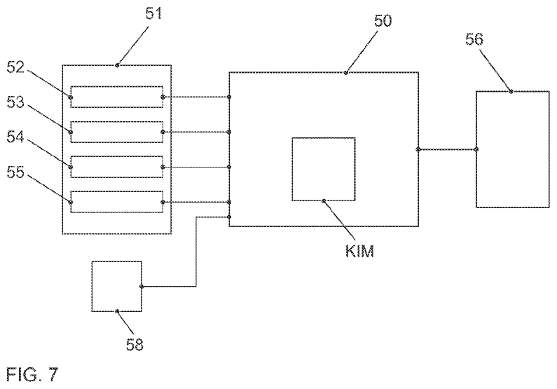

FIG. 7 illustrates a state of the AI module KIM after an expansion of its capabilities. As operation continues, the results may expand the performance of the existing system, since they deliver additional input data. The outputs 56 are now based on the current data and the additional input data. The described solution also increases the efficiency, since the idle times of the locomotion means, for example when parked or while stopped at traffic lights, are used for calculations that could be too complex for real-time processing during normal operation.

### LIST OF REFERENCE NUMERALS

10 Determining a state in which a system operated by the AI module is not in use for its primary purpose
11 Processing of stored data by the AI module by adding a random component
12 Evaluating a result of the processing of the stored data
13 Adapting the AI module depending on the evaluation
20 Device
21 Input
22 Monitoring module
23 Data module
24 Evaluation module
25 Control module
26 Checking module
27 Memory
28 User interface
30 Device
31 Memory
32 Processor
33 Input
34 Output
40 Locomotion means
41 Sensor system
42 User interface
43 Navigation system
44 Data transmission unit
45 Assistance system
46 Memory
47 Network
50 Computer-assisted system
51 Sources
52 Sensor data
53 User inputs
54 OTA data
55 Additional data
56 Output
57 Shift register
58 File
BZ Operating state
GD Stored data
KIM AI module
ZK Random component

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

6. The method of claim 1, wherein correlations in data sets are detected during the evaluation of results of the processing.

7. The method of claim 1, wherein adapting the AI module comprises a reduction of the input variables to be processed for a task.

8. The method of claim 1, wherein the AI module is used in a locomotion device.

9. The method of claim 8, wherein a state in which the system operated by the AI module is not in use for its primary purpose is determined when the locomotion device is parked or not in motion.

10. The method of claim 8, wherein the AI module is used for computer vision or autonomous driving tasks.

11. The method of claim 1, wherein the AI module is used in a robot, a medical device, or a consumer device.

12. A non-transitory recording medium with instructions which, when executed by a computer, cause the computer to:
determine a state in which a system operated by the AI module is not in use for its primary purpose;
process stored data by the AI module by adding a random component;
evaluate a result of the processing; and
adapt the AI module de ag on the evaluation.

13. A device for operating an AI module, with:
a monitoring module for determining a state in which a system operated by the AI module is not in use for its primary purpose;
a data module for providing stored data for processing by the AI module by adding a random component;
an evaluation module for evaluating a result of the processing; and
a control module for adapting the AI module (KIM) depending on the evaluation.

14. An AI module for use with a device according to claim 13.

15. A locomotion device wherein the locomotion device has an AI module according to claim 14.

16. The method of claim 2, wherein the random component is applied to the stored data.

17. The method of claim 2, wherein the random component is applied to at least one algorithm or at least one parameter of the AI module.

18. The method of claim 2, wherein correlations in data sets are detected during the evaluation of results of the processing.

19. The method of claim 3, wherein correlations in data sets are detected during the evaluation of results of the processing.

20. A locomotion device, wherein the locomotion device has a device according to claim 13.
